(19) United States
(12) Patent Application Publication
(10) Pub. No.: US 2018/0155538 A1
(43) Pub. Date: Jun. 7, 2018

(54) Heat Sealable Propylene-Based Films

(71) Applicant: ExxonMobil Chemical Patents Inc., Baytown, TX (US)

(72) Inventors: Lan Y. Cheng, Shanghai (CN); Jay K. Keung, Humble, TX (US); Etienne R. H. Lernoux, Grez-Doiceau (BE); Nai-Tong Lui, Kajang (MY)

(21) Appl. No.: 15/785,487

(22) Filed: Oct. 17, 2017

Related U.S. Application Data
(60) Provisional application No. 62/428,682, filed on Dec. 1, 2016.

(51) Int. Cl. C08L 23/14; C08L 23/12; B32B 27/32; B32B 27/08

(52) U.S. Cl. CPC C08L 23/14; C08L 23/12; B32B 27/32; B32B 2307/54; C08L 2205/025; C08L 2203/162; B32B 27/08

(57) ABSTRACT

Disclosed herein are multilayer films including at least one layer that comprises and/or is formed from a composition comprising a propylene polymer and a hydrocarbon resin. The films generally further include at least one layer that comprises and/or is made from a composition comprising a propylene-based elastomer and/or a propylene polymer. The multilayer films disclosed herein generally have a low sealing initiation temperature.

### CROSS-REFERENCE TO RELATED APPLICATIONS

The present application claims priority to U.S. Ser. No. 62/428,682, filed Dec. 1, 2016, which is herein incorporated by reference.

### FIELD OF THE INVENTION

The present invention relates to heat sealable propylene-based films, and in particular, to cast films suitable for food packaging applications.

### BACKGROUND OF THE INVENTION

Plastic films have found utility in a wide variety of packaging applications such as for example bags, pouches, tubes and trays. In many film applications, it is desirable to seal the film during the packaging operation. This may be accomplished by use of adhesives or by using heat sealing techniques. When heat sealing is used, it is important that the plastic film be readily heat sealable while also possessing other good physical and mechanical properties such as resistance to tearing, high tensile strength, and good processability in high speed equipment.

Film heat sealing is generally effected by means of heated flat surfaces, between which the films are forcefully pressed together at a temperature above the sealing initiation temperature of the film. When use is made of equipment such as vertical form, fill and seal machines, the bag is filled with the contents to be packaged while the bottom seal is still hot. Cooling the seal would entail too long a waiting time, thus lengthening the cycle time and increasing operating costs. Consequently, the film must be one which enables the formation of a strong seal even as the seal formed is at or near the seal formation temperature.

It is evident that an important characteristic for a heat sealable film is the temperature at which the sealing begins, i.e., the heat sealing initiation temperature. It is desired to operate at as low a temperature as possible because (1) it broadens the heat sealable range, (2) it permits higher productivity due to less time for cooling, (3) it requires less energy to heat seal at lower temperature, (4) at a lower heat sealing initiation temperature, the film is more forgiving of inadequacies in the heat sealing equipment, and (5) the packaged food/product has less exposure to heat. Other desirable properties for heat sealable films include high stiffness, good optical properties, e.g., clarity, good barrier properties, and a low TD Elmendorf tear strength to facilitate easy opening packaging.

Many commonly used plastic materials that are used in the formation of film products could benefit from an improvement of their heat sealing characteristics. For example, crystalline polypropylene films have found extensive use in the field of packaging. Polypropylene films, in both oriented and non-oriented form, are used widely in packaging applications because of their superiority in mechanical properties such as tensile strength, rigidity, and surface hardness, optical properties such as gloss and transparency, and food hygiene such as freedom from toxicity and odor. However, polypropylene films, when coextruded with currently available sealant resins, typically require heat sealing initiation temperatures (SIT) upwards of about 125° C., before adequate film seal strengths (at least 200 Win) are obtained.

Attempts have been made to lower the SIT of polypropylene films, for example, by use of propylene terpolymers or propylene-based elastomers in a sealing layer. For instance, U.S. Pat. No. 8,617,717 describes monolayer and coextruded films employing blends of propylene-based elastomers and polypropylene resins, and other polyolefin resins, to overcome the heat seal limitations of polypropylene films. Other references of interest include U.S. Pat. No. 8,354,465, U.S. Pat. No. 8,609,772, and U.S. Pat. No. 8,664,320.

However, to date none of these attempts have successfully reduced the SIT of polypropylene films below 100° C. Therefore, there remains a need to provide polypropylene films having lowered SIT and/or lowered TD Elmendorf tear strength while not compromising other desired properties, such as good stiffness, toughness, clarity, and barrier properties.

### SUMMARY OF THE INVENTION

This invention fulfills the need for polypropylene films having lowered SIT and/or TD Elmendorf tear strength while maintaining or improving other desired film properties by providing multilayer propylene-based films comprising at least one layer including a propylene polymer and a hydrocarbon resin.

The present invention relates to multilayer films that comprise a first layer, A, and optionally at least one of a second layer, B, and a third layer, C. Preferably, the multilayer films comprise at least one B layer. The A layer generally comprises from about 1 wt % to about 50 wt % of a hydrocarbon resin and from about 50 wt % to about 99 wt % of a propylene polymer. The propylene polymer can be a propylene homopolymer or a copolymer of propylene and at least one comonomer selected from ethylene and C₄-C₂₀ alpha-olefins, wherein the copolymer has a propylene content of at least 80 wt % and has a melting point of greater than 115° C. The hydrocarbon resin can comprise an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, or a combination thereof. The B layer generally comprises a propylene-based elastomer. Often, the B layer may comprise from about 10 to about 90 wt % of a propylene polymer and from about 90 wt % to about 10 wt % of the propylene-based elastomer. The propylene polymer can be a propylene homopolymer or a copolymer of propylene and at least one comonomer selected from ethylene and C₄-C₂₀ alpha-olefins, wherein the copolymer has a propylene content of at least 80 wt % and has a melting point of greater than 115° C. Preferably, the propylene-based elastomer has a propylene content of at least 75 wt %, an mm triad tacticity of greater than 75%, a melting point of less than 115° C., and a heat of fusion of less than 65 J/g. Often, the propylene-based elastomer can have a propylene content of from about 80 wt % to about 97 wt % and an ethylene content of from 3 wt % to about 20 wt %. Generally, the C layer comprises a propylene polymer, wherein the propylene polymer is a propylene homopolymer or a copolymer of propylene and at least one comonomer selected from ethylene and C₄-C₂₀ alpha-olefins, and wherein the copolymer has a propylene content of at least 80 wt % and has a melting point of greater than 115° C.

The present invention also relates to the use of a blend of a propylene polymer and a hydrocarbon resin in a first layer of a multilayer film to reduce the TD Elmendorf tear strength and/or to increase the MD 1% secant modulus of the multilayer film as compared to the same film not comprising the hydrocarbon resin in the first layer. Preferably, the blend comprises from about 1 wt % to about 50 wt % of the hydrocarbon resin and from about 50 wt % to about 99 wt % of the propylene polymer based on the weight of the blend. Preferably, the propylene polymer can be a propylene homopolymer or a copolymer of propylene and at least one comonomer selected from ethylene and C₄-C₂₀ alpha-olefins, wherein the copolymer has a propylene content of at least 80 wt % and has a melting point of greater than 115° C.; and the hydrocarbon resin can comprise an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, or a combination thereof. Preferably, the blend in the first layer of the multilayer film may be used in combination with a propylene-based elastomer in a second layer to further reduce the SIT of the film as compared to the same film not comprising the hydrocarbon resin in the first layer or the propylene-based elastomer in the second layer. Preferably, the propylene-based elastomer has a propylene content of at least 75 wt %, an mm triad tacticity of greater than 75%, a melting point of less than 115° C., and a heat of fusion of less than 65 J/g.

### BRIEF DESCRIPTION OF DRAWINGS

FIG. 1 to FIG. 5 shows the exemplary layer structures of the multilayer films of the present invention.

### DETAILED DESCRIPTION

Disclosed herein are multilayer films comprising a first layer, A (“A layer”), and at least one of a second layer, B (“B layer”) and a third layer, C (“C layer”). Preferably, the multilayer films comprise at least one B layer. The A layer can comprise and/or be formed from a first layer composition comprising a propylene polymer and a hydrocarbon resin. The B layer can comprise and/or be formed from a second layer composition comprising a propylene-based elastomer. The C layer can comprise and/or be formed from a third layer composition comprising a propylene polymer.

Without wishing to be bound by theory, it is believed that the hydrocarbon resin modifies the physical properties of the propylene polymer in the A layer, resulting in improved end use film properties. For instance, it is believed that the addition of the hydrocarbon resin increases the elastic modulus of the propylene polymer, resulting in a film and/or film layer having improved stiffness, clarity, and lowered tear strength. It is also believed that the use of a propylene-based elastomer in a B layer contiguous to the A layer results in a synergistic improvement in stiffness, clarity, and barrier properties, as well as lowered SIT of the present films.

### Definitions

The term “polymer” as used herein includes, but is not limited to, homopolymers, copolymers, terpolymers, etc., and alloys and blends thereof. The term “polymer” as used herein also includes impact, block, graft, random, and alternating copolymers. The term “polymer” shall further include all possible geometrical configurations unless otherwise specifically stated. Such configurations may include isotactic, syndiotactic, and random symmetries.

As used herein, unless specified otherwise, the term “copolymer(s)” refers to polymers formed by the polymerization of at least two different monomers. For example, the term “copolymer” includes the copolymerization reaction product of propylene and an alpha-olefin, such as ethylene, 1-hexene. However, the term “copolymer” is also inclusive of, for example, the copolymerization of a mixture of ethylene, propylene, 1-hexene, and 1-octene.

As used herein, when a polymer is referred to as “comprising a monomer,” the monomer is present in the polymer in the polymerized form of the monomer or in the derivative form of the monomer.

As used herein, “thermoplastic” includes only those thermoplastic materials that have not been functionalized or substantially altered from their original chemical composition. For example, as used herein, propylene polymer, propylene ethylene copolymers, propylene alpha-olefin copolymers, polyethylene and polystyrene are thermoplastics. However, maleated polyolefins are not within the meaning of thermoplastic as used herein.

Unless otherwise specified, the term “elastomer”, as used herein, refers to any polymer or composition of polymers consistent with the ASTM D1566 definition.

For purposes of this invention and the claims thereto, a “nucleating agent” or “nucleator” is a molecule having a molecular weight of less than 1,000 g/mole that decreases the crystallization time of thermoplastic materials, examples of which include metal salts or organic acids, sodium benzoate, and other compounds known in the art. For purposes of the invention, a “clarifying agent” is a nucleating agent that is soluble in the melt phase of the thermoplastic materials.

As used herein, “molecular weight” means weight average molecular weight (“Mw”). Mw is determined using Gel Permeation Chromatography. Molecular Weight Distribution (“MWD”) means Mw divided by number average molecular weight (“Mn”). (For more information, see U.S. Pat. No. 4,540,753 to Cozewith et al. and references cited therein, and in Verstrate et al., 21 Macromolecules 3360 (1998)). The “Mz” value is the high average molecular weight value, calculated as discussed by A. R. Cooper in Concise Encyclopedia of Polymer Science and Engineering 638-39 (J. I. Kroschwitz, ed. John Wiley & Sons 1990).

As used herein, weight percent (“wt %”), unless noted otherwise, means a percent by weight of a particular component based on the total weight of the mixture containing the component. For example, if a mixture contains three pounds of sand and one pound of sugar, then the sand comprises 75 wt % (3 lbs. sand/4 lbs. total mixture) of the mixture and the sugar 25 wt %.

For purposes of the invention, unless otherwise specified heat of fusion and melting point (T_{M}) values are determined by differential scanning calorimetry (DSC) in accordance with the following procedure. From about 6 mg to about 10 mg of a sheet of the polymer pressed at approximately 200° C. to 230° C. is removed with a punch die. This is annealed at room temperature for at least 2 weeks. At the end of this period, the sample is placed in a Differential Scanning calorimeter (TA Instruments Model 2920 DSC) and cooled to about −50° C. to about −70° C. The sample is heated at 10° C./min to attain a final temperature of about 200° C. to about 220° C. The thermal output during this heating is recorded. The melting peak of the sample is typically peaked at 30° C. to 175° C. and occurs between the temperatures of 0° C. and 200° C. The area under the thermal output curve, measured in Joules, is a measure of the heat of fusion. The melting point is recorded as the temperature of the greatest heat absorption within the range of melting of the sample.

When referred to herein, a polymer's “clarity,” “clarity percentage,” “haze” or “haze percentage” are determined in the absence of any colorant, colored pigments, dyes or other additives meant to affect the final color or opacity of the polymer. In particular, if an inventive composition described herein satisfies the clarity and haze percentages of the given formulae before the addition of colorants, colored pigments, dyes or other additives, but does not after the addition of some additive, it does not cease to be an inventive composition according to the present invention.

As used herein, the “sealing initiation temperature (SIT)” of a film, unless refers to the minimum temperature at which the measurable seal strength is observed. The seal strength can be measured based on ASTM F 88 method.

As used herein, the designation “MD” indicates a measurement in the machine direction, and “TD” indicates a measurement in the transverse direction.

As used herein, an “unoriented film” refers to a film not drawn or stretched intensively in MD or TD. For example, unoriented films of the invention are preferably stretched at ratio of less than 10, preferably less than 5, and ideally less than 2 in both MD and TD. Preferred unoriented films of the invention include blown films, cast films, and laminated films, ideally cast films.

### Propylene Polymer

The inventive multilayer films generally comprise at least one layer, e.g., the A layer, that comprises and/or is formed from a composition comprising a propylene polymer. The propylene polymer of each layer is independently selected. That is, the propylene polymers may differ from one another between any and/or all of the layers, or can be the same between any and/or all of the layers. The following description and/or limitation to “propylene polymers” is applicable to any propylene polymer that is useful in any of these multiple layers, unless expressly indicated otherwise. Also, as described herein, the term “propylene polymer” and “polypropylene” is interchangeable.

Suitable propylene polymers useful in the present multilayer films have a melting point above about 115° C., or above about 120° C., or above about 130° C. Suitable propylene polymers may be propylene homopolymer (or “homopolypropylene”) or copolymers of propylene and at least one comonomer selected from ethylene and C₄-C₂₀ alpha-olefins (or “polypropylene copolymer”).

The propylene polymers useful in the present invention may have some level of isotacticity. Thus, in any embodiment, the propylene polymer may comprise isotactic polypropylene. As used herein, “isotactic” is defined as having at least 60% isotactic pentads according to analysis by ¹³C-NMR. Alternatively, the propylene polymer may include atactic sequences or syndiotactic sequences. For example, a suitable homopolypropylene can have at least 85% syndiotacticity, and alternatively at least 90% syndiotacticity. As used herein, “syndiotactic” is defined as having at least 60% syndiotactic pentads according to analysis by ¹³C-NMR. Atactic polypropylene is defined to be less than 10% isotactic or syndiotactic pentads. Preferred atactic polypropylenes typically have an Mw of 20,000 up to 1,000,000.

Often, the propylene polymer is or comprises homopolypropylene. Preferably, the homopolypropylene has a melt flow rate (MFR) (ASTM D 1238, 230° C., 2.16 kg) in the range from 0.1 dg/min to 500 dg/min, or from 0.5 dg/min to 200 dg/min, or from 0.5 dg/min to 100 dg/min, or from 1 dg/min to 50 dg/min, or from and from 1.5 dg/min to 20 dg/min, or from 2 dg/min to 10 dg/min. Preferably, the homopolypropylene has a 1% secant flexural modulus ranging from 100 MPa to 2300 MPa, preferably 300 MPa to 2100 MPa, and more preferably from 500 MPa to 2000 MPa. Preferably, the homopolypropylene has a molecular weight distribution (Mw/Mn) of up to 40, preferably ranging from 1.5 to 10, or from 1.8 to 7, or from 1.9 to 5, or from 2.0 to 4.

Preferably, homopolypropylene has at least 85% isotacticity, more preferably at least 90% isotacticity. Suitable isotactic polypropylene has a melt temperature (Tₘ) ranging from a low of about 130° C., or about 140° C., 150° C., or 160° C. to a high of about 160° C., 170° C., or 175° C., such as from 150° C. to 170° C. The isotactic polypropylene preferably has a glass transition temperature (T_{g}) ranging from a low of about −5° C., −3° C., or 0° C. to a high of about 2° C., 5° C., or 10° C., such as from −3° C. to 5° C. The crystallization temperature (T_{c}) of the isotactic polypropylene preferably ranges from a low of about 95° C., 100° C., or 105° C. to a high of about 110° C., 120° C. or 130° C., such as 100° C. to 120° C., as measured by differential scanning calorimetry (DSC) at 10° C./min. Furthermore, the isotactic polypropylene preferably has a crystallinity of at least 25 percent as measured by DSC at 10° C./min Generally, the isotactic polypropylene has a melt flow rate of less than about 10 dg/min, often less than about 5 dg/min, and often less than about 3 dg/min Often, the isotactic polypropylene has a melt flow rate ranging from about 2 dg/min to about 5 dg/min. A preferred isotactic polypropylene has a heat of fusion of greater than 75 J/g, or greater than 80 J/g, or greater than 90 J/g to a high of about 150 J/g, such as from about 80 J/g to about 120 J/g. In any embodiment, the isotactic polypropylene may have a density of from about 0.85 g/cc to about 0.93 g/cc. Preferably, the isotactic polypropylene has a density of from about 0.88 g/cc to about 0.92 g/cc, more preferably from about 0.90 g/cc to about 0.91 g/cc.

An illustrative isotactic polypropylene has a weight average molecular weight (Mw) from about 200,000 to about 600,000 g/mole, and a number average molecular weight (Mn) from about 80,000 to about 200,000 g/mole. A more preferable isotactic polypropylene has an Mw from about 300,000 to about 500,000 g/mole, and an Mn from about 90,000 to about 150,000 g/mole. In any embodiment, the isotactic polypropylene may have an MWD within a range having a low of 1.5, 1.8. or 2.0 and a high of 4.5, 5, 10, 20, or 40, such as from 1.5 to 4.0.

Alternatively, the propylene polymer is a polypropylene copolymer having a propylene content in an amount greater than about 80 wt %, ideally greater than about 90 wt %, such as from about 93 wt % to about 99.5 wt %, and a comonomer content in an amount ranging from a low of about 0.1, 0.25, 0.5, 1, 2, 3, 4, or 6 wt % to a high of about 1, 3, 5, 7, 8, 9, 15, or 20 wt %, such as from about 0.5 wt % to about 7 wt % based on the weight of the copolymer.

Suitable comonomer(s) can be selected from the group consisting of ethylene and C₄ to C₂₀ linear, branched or cyclic monomers, preferably C₄ to C₁₂ linear or branched alpha-olefins. Suitable comonomers may be present at up to 20 wt %, preferably from 0 to 20 wt %, more preferably from 0.1 to 10 wt %, more preferably from 0.5 to 8 wt % by weight of the propylene-based copolymer.

Preferred linear alpha-olefins useful as comonomers include C₃ to C₈ alpha-olefins, more preferably 1-butene, 1-hexene, and 1-octene, even more preferably 1-butene. Preferred branched alpha-olefins include 4-methyl-1-pentene, 3-methyl-1-pentene, and 3,5,5-trimethyl-1-hexene, 5-ethyl-1-nonene.

Optionally, aromatic-group-containing comonomers, non-aromatic cyclic group containing comonomers, or diolefin comonomers can be comprised in the propylene polymers. These comonomers can contain up to 30 carbon atoms, e.g., from 4 to 20 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, vinylnorbornene, norbornadiene, ethylidene norbornene, divinylbenzene, dicyclopentadiene or higher ring containing diolefins with or without substituents at various ring positions. Often, one or more dienes are present in the propylene-based copolymer at up to 10 wt %, preferably from 0.1 to 5.0 wt %, more preferably from 0.1 to 3 wt % based upon the total weight of the copolymer.

Preferably, the polypropylene copolymer can be selected from random copolymers (RCP), block copolymers, impact copolymers (ICP) (e.g., an intimate blend of polypropylene homopolymer and an ethylene-propylene elastomer, also known in the art as heterophasic copolymers), and terpolymers. Preferred RCPs include single phase polypropylene copolymers having up to about 9 wt %, preferably about 2 wt % to about 8 wt %, of an alpha olefin comonomer, preferably ethylene.

Preferably, useful propylene-based copolymers have a weight average molecular weight greater than 8,000 g/mol, alternatively greater than 10,000 g/mol, alternatively greater than 12,000 g/mol, and alternatively than 20,000 g/mol. Preferably, useful propylene-based copolymers have a weight average molecular weight less than 1,000,000 g/mol, and alternatively less than 800,000. A desirable propylene-based copolymer may comprise any upper molecular weight limit with any lower molecular weight limit described herein.

Useful propylene-based copolymers have an Mw/Mn ranging from 1.5 to 10, preferably from 1.6 to 7, more preferably from 1.7 to 5, and most preferably from 1.8 to 4. Often, suitable propylene-based copolymers have a 1% secant flexural modulus ranging from 100 MPa to 2300 MPa, preferably from 200 MPa to 2100 MPa, and more preferably from 300 MPa to 2000 MPa. Often, suitable propylene-based polymers have an MFR ranging from 0.1 dg/min to 2500 dg/min, preferably from 0.3 dg/min to 500 dg/min.

Often, the propylene polymers are or comprise a “tailored crystallinity resin” (“TCR”). Suitable TCRs include any modified polypropylene comprising an in situ reactor blend of a higher molecular weight propylene/ethylene random copolymer and a lower molecular weight substantially isotactic homopolypropylene, such as those described in U.S. Pat. No. 4,950,720, incorporated by reference as if fully disclosed herein.

Often, the propylene polymers useful in the invention can be nucleated with one or more nucleating agents prior to the use in the present multilayer film, e.g., prior to incorporation in the multilayer film and/or prior to the addition of the hydrocarbon resin. Alternatively, the polypropylene can be non-nucleated, i.e., nucleating agents are absent. In any embodiment, suitable nucleating agents may be selected from the group consisting of sodium benzoate, talc, glycerol alkoxide salts, cyclic carboxylic acid salts, bicyclic carboxylic acid salts, glycerolates, and hexahydrophtalic acid salts. Nucleating agents include HYPERFORM™ additives, such as HPN-68, HPN-68L, HPN-20, HPN-20E, MILLAD™ additives (e.g., MILLAD™ 3988) (Milliken Chemicals, Spartanburg, S.C.) and organophosphates such as NA-11 and NA-21 (Amfine Chemicals, Allendale, N.J.). In any embodiment, suitable nucleating agents may comprise at least one bicyclic carboxylic acid salt. In any embodiment, suitable nucleating agents may comprise bicycloheptane dicarboxylic acid, disodium salt such as bicyclo [2.2.1] heptane dicarboxylate. In any embodiment, suitable nucleating agents may be a blend of components comprising bicyclo [2.2.1] heptane dicarboxylate, disodium salt, 13-docosenamide, and amorphous silicon dioxide. In any embodiment, suitable nucleating agents may be cyclohexanedicarboxylic acid, calcium salt or a blend of cyclohexanedicarboxylic acid, calcium salt, and zinc stearate. In any embodiment, suitable nucleating agents include clarifying agents.

The method of making the propylene polymers is not critical. Illustrative polymerization methods include, but are not limited to, slurry, bulk phase, solution phase, and any combination thereof. Any catalyst system appropriate for the polymerization of polyolefins may be used, such as Ziegler-Natta-type catalysts, metallocene-type catalysts, or combinations thereof. Such catalysts are well known in the art, and are described in, for example, ZIEGLER CATALYSTS (Gerhard Fink, Rolf Mülhaupt and Hans H. Brintzinger, eds., Springer-Verlag 1995); Resconi et al., Selectivity in Propene Polymerization with Metallocene Catalysts, 100 CHEM. REV. 1253-1345 (2000); and I, II METALLOCENE-BASED POLYOLEFINS (Wiley & Sons 2000).

Preferably the propylene polymers are made by the catalysts, activators and processes described in U.S. Pat. No. 6,342,566, U.S. Pat. No. 6,384,142, WO 03/040201, WO 97/19991 and U.S. Pat. No. 5,741,563. Impact copolymers may be prepared by the process described in U.S. Pat. No. 6,342,566 and U.S. Pat. No. 6,384,142.

Examples of particularly suitable propylene polymers include homopolypropylenes commercially available from ExxonMobil Chemical Company under the names of PP4712, and PP4612, from Total Petrochemical under the names of 3371, 3270, 3576X; and random copolymers of polypropylene commercially available from ExxonMobil Chemical Company under the names of PP9513; from INEOS Olefins & Polymers under the name of ELTEX™ P KS400, from Basell under the name of Adsyl™ 6C30F, and from Borealis under the name of BorPURE™ RD208CF; and terpolymers of propylene such as commercially available from INEOS Olefins & Polymer under the names of ELTEX™ P KS351.

### Hydrocarbon Resin

The inventive multilayer films generally comprise at least one layer, e.g., the A layer, that comprises and/or is formed from a polymer composition comprising a hydrocarbon resin.

Suitable hydrocarbon resins include, but are not limited to, aliphatic hydrocarbon resins, at least partially hydrogenated aliphatic hydrocarbon resins, aliphatic/aromatic hydrocarbon resins, at least partially hydrogenated aliphatic aromatic hydrocarbon resins, aromatic resins, at least partially hydrogenated aromatic hydrocarbon resins, cycloaliphatic hydrocarbon resins, at least partially hydrogenated cycloaliphatic resins, cycloaliphatic/aromatic hydrocarbon resins, cycloaliphatic/aromatic at least partially hydrogenated hydrocarbon resins, polyterpene resins, terpene-phenol resins, rosin esters, rosin acids, grafted resins, and mixtures of two or more of the foregoing. The hydrocarbon resins may be polar or apolar.

In any embodiment, suitable hydrocarbon resins may comprise one or more hydrocarbon resins produced by the thermal polymerization of cyclopentadiene (CPD) or substituted CPD, which may further include aliphatic or aromatic monomers as described later. The hydrocarbon resin may be a non-aromatic resin or an aromatic resin. The hydrocarbon resin may have an aromatic content between 0 wt % and 60 wt %, or between 1 wt % and 60 wt %, or between 1 wt % and 40 wt %, or between 1 wt % and 20 wt %, or between 10 wt % and 20 wt %. Alternatively or additionally, the hydrocarbon resin may have an aromatic content between 15 wt % and 20 wt %, or between 1 wt % and 10 wt %, or between 5 wt % and 10 wt %. Preferred aromatics that may be in the hydrocarbon resin include one or more of styrene, indene, derivatives of styrene, and derivatives of indene. Particularly preferred aromatic olefins include styrene, alpha-methylstyrene, beta-methylstyrene, indene, and methylindenes, and vinyl toluenes. Styrenic components include styrene, derivatives of styrene, and substituted styrenes. In general, styrenic components do not include fused-rings, such as indenics.

In any embodiment, suitable hydrocarbon resins may comprise hydrocarbon resins produced by the catalytic (cationic) polymerization of linear dienes. Such monomers are primarily derived from Steam Cracked Naphtha (SCN) and include C5 dienes such as piperylene (also known as 1,3-pentadiene). Polymerizable aromatic monomers can also be used to produce resins and may be relatively pure, e.g., styrene, -methyl styrene, or from a C₉-aromatic SCN stream. Such aromatic monomers can be used alone or in combination with the linear dienes previously described. “Natural” monomers can also be used to produce resins, e.g., terpenes such as alpha-pinene or beta-carene, either used alone or in high or low concentrations with other polymerizable monomers. Typical catalysts used to make these resins are AlCl₃ and BF₃, either alone or complexed. Mono-olefin modifiers such as 2-methyl, 2-butene may also be used to control the MWD of the final resin. The final resin may be partially or totally hydrogenated.

In any embodiment, suitable hydrocarbon resins may be at least partially hydrogenated or substantially hydrogenated. As used herein, “at least partially hydrogenated” means that the material contains less than 90% olefinic protons, or less than 75% olefinic protons, or less than 50% olefinic protons, or less than 40% olefinic protons, or less than 25% olefinic protons, such as from 20% to 50% olefinic protons. As used herein, “substantially hydrogenated” means that the material contains less than 5% olefinic protons, or less than 4% olefinic protons, or less than 3% olefinic protons, or less than 2% olefinic protons, such as from 1% to 5% olefinic protons. The degree of hydrogenation is typically conducted so as to minimize and avoid hydrogenation of the aromatic bonds.

In any embodiment, suitable hydrocarbon resins may comprise one or more oligomers such as dimers, trimers, tetramers, pentamers, and hexamers. The oligomers may be derived from a petroleum distillate boiling in the range of 30° C.-210° C. The oligomers may be derived from any suitable process and are often derived as a byproduct of resin polymerization. Suitable oligomer streams may have an Mn between 130 and 500, or between 130 and 410, or between 130 and 350, or between 130 and 270, or between 200 and 350, or between 200 and 320. Examples of suitable oligomer streams include, but are not limited to, oligomers of cyclopentadiene and substituted cyclopentadiene, oligomers of C₄-C₆ conjugated diolefins, oligomers of C₈-C₁₀ aromatic olefins, and combinations thereof. Other monomers may be present. These include C₄-C₆ mono-olefins and terpenes. The oligomers may comprise one or more aromatic monomers and may be at least partially hydrogenated or substantially hydrogenated.

Preferably, suitable hydrocarbon resins comprises a dicyclopentadiene, cyclopentadiene, and methylcyclopentadiene derived content of about 60 wt % to about 100 wt % of the total weight of the hydrocarbon resin. In any embodiment, suitable hydrocarbon resins may have a dicyclopentadiene, cyclopentadiene, and methylcyclopentadiene derived content of about 70 wt % to about 95 wt %, or about 80 wt % to about 90 wt %, or about 95 wt % to about 99 wt % of the total weight of the hydrocarbon resin. Preferably, the hydrocarbon resin may be a hydrocarbon resin that includes, in predominant part, dicyclopentadiene derived units. The term “dicyclopentadiene derived units”, “dicyclopentadiene derived content”, and the like refers to the dicyclopentadiene monomer used to form the polymer, i.e., the unreacted chemical compound in the form prior to polymerization, and can also refer to the monomer after it has been incorporated into the polymer, which by virtue of the polymerization reaction typically has fewer hydrogen atoms than it does prior to the polymerization reaction.

In any embodiment, suitable hydrocarbon resins may have a dicyclopentadiene derived content of about 50 wt % to about 100 wt % of the total weight of the hydrocarbon resin, more preferably about 60 wt % to about 100 wt % of the total weight of the hydrocarbon resin, even more preferably about 70 wt % to about 100 wt % of the total weight of the hydrocarbon resin. Accordingly, in any embodiment, suitable hydrocarbon resins may have a dicyclopentadiene derived content of about 50% or more, or about 60% or more, or about 70% or more, or about 75% or more, or about 90% or more, or about 95% or more, or about 99% or more of the total weight of the hydrocarbon resin.

Suitable hydrocarbon resins may include up to 5 wt % indenic components, or up to 10 wt % indenic components. Indenic components include indene and derivatives of indene. Often, the hydrocarbon resin includes up to 15 wt % indenic components. Alternatively, the hydrocarbon resin is substantially free of indenic components.

Preferred hydrocarbon resins have a melt viscosity of from 300 to 800 centipoise (cPs) at 160° C., or more preferably of from 350 to 650 cPs at 160° C. Preferably, the melt viscosity of the hydrocarbon resin is from 375 to 615 cPs at 160° C., or from 475 to 600 cPs at 160° C. The melt viscosity may be measured by a Brookfield viscometer with a type “J” spindle according to ASTM D 6267.

Suitable hydrocarbon resins have an Mw greater than about 600 g/mole or greater than about 1000 g/mole. In any embodiment, the hydrocarbon resin may have an Mw of from about 600 to about 1400 g/mole, or from about 800 g/mole to about 1200 g/mole. Preferred hydrocarbon resins have a weight average molecular weight of from about 800 to about 1000 g/mole. Suitable hydrocarbon resins may have an Mn of from about 300 to about 800 g/mole, or from about 400 to about 700 g/mole, or more preferably from about 500 to about 600 g/mole. Suitable hydrocarbon resins may have an Mz of from about 1250 to about 3000 g/mole, or more preferably from about 1500 to about 2500 g/mole. In any embodiment, suitable hydrocarbon resins may have an Mw/Mn of 4 or less, preferably from 1.3 to 1.7.

Preferred hydrocarbon resins have a glass transition temperature (Tg) of from about 30° C. to about 200° C., or from about 0° C. to about 150° C., or from about 50° C. to about 160° C., or from about 50° C. to about 150° C., or from about 50° C. to about 140° C., or from about 80° C. to about 100° C., or from about 85° C. to about 95° C., or from about 40° C. to about 60° C., or from about 45° C. to about 65° C. Preferably, suitable hydrocarbon resins have a Tg from about 60° C. to about 90° C. DSC is used to determine glass transition temperature at 10° C./min.

Specific examples of commercially available hydrocarbon resins include Oppera™ PR 100, 100A, 101, 102, 103, 104, 105, 106, 111, 112, 115, and 120 materials, and Oppera™ PR 131 hydrocarbon resins, all available from ExxonMobil Chemical Company, ARKON™ M90, M100, M115 and M135 and SUPER ESTER™ rosin esters available from Arakawa Chemical Company of Japan, SYLVARES™ phenol modified styrene- and methyl styrene resins, styrenated terpene resins, ZONATAC terpene-aromatic resins, and terpene phenolic resins available from Arizona Chemical Company, SYLVATAC™ and SYLVALITE™ rosin esters available from Arizona Chemical Company, NORSOLENE™ aliphatic aromatic resins available from Cray Valley of France, DERTOPHENE™ terpene phenolic resins available from DRT Chemical Company of Landes, France, EASTOTAC™ resins, PICCOTACT™ C5/C9 resins, REGALITE™ and REGALREZ™ aromatic and REGALITE™ cycloaliphatic/aromatic resins available from Eastman Chemical Company of Kingsport, Tenn., WINGTACK™ ET and EXTRA available from Goodyear Chemical Company, FORAL™, PENTALYN™, AND PERMALYN™ rosins and rosin esters available from Hercules (now Eastman Chemical Company), QUINTONE™ acid modified C5 resins, C5/C9 resins, and acid modified C5/C9 resins available from Nippon Zeon of Japan, and LX™ mixed aromatic/cycloaliphatic resins available from Neville Chemical Company, CLEARON hydrogenated terpene aromatic resins available from Yasuhara. The preceding examples are illustrative only and by no means limiting.

These commercial compounds generally have a Ring and Ball softening point (measured according to ASTM E-28 (Revision 1996)) of about 10° C. to about 200° C., more preferably about 50° C. to about 180° C., more preferably about 80° C. to about 175° C., more preferably about 100° C. to about 160° C., more preferably about 110° C. to about 150° C., and more preferably about 125° C. to about 140° C., wherein any upper limit and any lower limit of softening point may be combined for a preferred softening point range. For hydrocarbon resins a convenient measure is the ring and ball softening point determined according to ASTM E-28.

The hydrocarbon resin of the present invention can be blended with the propylene polymer to produce the polymer composition of the A layer of the multilayer film. The hydrocarbon resin can also be pre-blended with a propylene polymer or other polymers that are miscible with the propylene polymers as described herein, and then blended with the propylene polymer to form the polymer composition. Often, the pre-blend can comprise the hydrocarbon resin ranging from a lower limit of about 20%, 30%, 40%, 50%, 60%, 70%, or 80% to an upper limit of about 90%, 80%, 70%, 60%, 50% or 40%, by weight of the pre-blend, such as from about 10% to about 90%, or from 20% to 80%, or from 30% to 80% by weight based on the total weight of the blend, or any ranges between two values as described above so long as the lower limit value is less than the upper limit value.

### Propylene-Based Elastomer

The inventive multilayer films preferably comprise at least one layer, e.g., the B layer, that comprises and/or is formed from a polymer composition comprising a propylene-based elastomer. As used herein, the term “propylene-based elastomer” means a polymer having a melt flow rate in the range of 0.5 to 50 dg/min., a heat of fusion of less than 75 J/g and comprising 65 to 99 wt % of polymer units derived from propylene and 1 to 35 wt % of polymer units derived from ethylene, a C4 to C20 alpha-olefin comonomer, a diene, or mixtures thereof, based upon total weight of the propylene-based elastomer.

Particularly suitable propylene-based elastomers include copolymers of propylene and at least one comonomer selected from ethylene and C4-C₁₀ alpha-olefins. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

Preferably, the propylene content of the propylene-based elastomer may range from an upper limit of about 99 wt %, about 97 wt %, about 95 wt %, about 94 wt %, about 92 wt %, about 90 wt %, or about 85 wt %, to a lower limit of about 75 wt %, about 80 wt %, about 82 wt %, about 85 wt %, or about 90 wt %, for example, from about 75 wt % to about 99%, from about 80 wt % to about 99 wt %, or from about 90 wt % to about 97 wt %, based on the weight of the propylene-based elastomer. Preferably, the comonomer content of the propylene-based elastomer may range from about 1 to about 25 wt %, or about 3 to about 25 wt %, or about 3 to about 20 wt %, or about 3 to about 18 wt %, or from about 3 wt % to about 11 wt %, of the propylene-based elastomer. The comonomer content may be adjusted so that the propylene-based elastomer has a heat of fusion of less than about 80 J/g, a melting point of about 115° C. or less, and a crystallinity of about 2% to about 65% of the crystallinity of isotactic polypropylene, and a fractional melt mass-flow rate of about 0.5 to about 20 g/min.

Preferably, the comonomer is ethylene, 1-hexene, or 1-octene, with ethylene being most preferred. Where the propylene-based elastomer comprises ethylene-derived units, the propylene-based elastomer may comprise an ethylene content from about 3 to about 25 wt %, or about 4 to about 20 wt %, or about 9 to about 18 wt %. Often, the propylene-based elastomer consists essentially of units derived from propylene and ethylene, i.e., the propylene-based elastomer does not contain any other comonomer in an amount other than that typically present as impurities in the ethylene and/or propylene feedstreams used during polymerization, or in an amount that would materially affect the heat of fusion, melting point, crystallinity, or fractional melt mass-flow rate of the propylene-based elastomer, or in an amount such that any other comonomer is intentionally added to the polymerization process.

Often, the propylene-based elastomer may comprise more than one comonomer. Preferred propylene-based elastomers having more than one comonomer include propylene-ethylene-octene, propylene-ethylene-hexene, and propylene-ethylene-butene polymers. Where more than one comonomer is present, a single comonomer may be present at a concentration of less than about 5 wt % of the propylene-based elastomer, but the total comonomer content of the propylene-based elastomer is generally about 5 wt % or greater.

The propylene-based elastomer may have an mm triad tacticity index as measured by ¹³C NMR, of at least about 75%, at least about 80%, at least about 82%, at least about 85%, or at least about 90%. Preferably, the propylene-based elastomer has an mm triad tacticity of about 75 to about 99%, or about 80 to about 99%. In some embodiments, the propylene-based elastomer may have an mm triad tacticity of about 75 to 97%. The “mm triad tacticity index” of a polymer is a measure of the relative isotacticity of a sequence of three adjacent propylene units connected in a head-to-tail configuration. More specifically, in the present invention, the mm triad tacticity index (also referred to as the “mm Fraction”) of a polypropylene homopolymer or copolymer is expressed as the ratio of the number of units of meso tacticity to all of the propylene triads in the copolymer:

$$mm Fraction = \frac{PPP ( mm )}{PPP ( mm ) + PPP ( mr ) + PPP ( rr )}$$

where PPP(mm), PPP(mr) and PPP(rr) denote peak areas derived from the methyl groups of the second units in the possible triad configurations for three head-to-tail propylene units, shown below in Fischer projection diagrams:

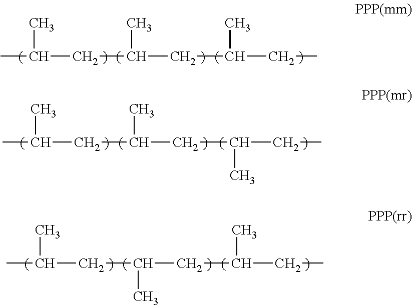

The calculation of the mm Fraction of a propylene polymer is described in U.S. Pat. No. 5,504,172 (homopolymer: column 25, line 49 to column 27, line 26; copolymer: column 28, line 38 to column 29, line 67). For further information on how the mm triad tacticity can be determined from a ¹³C-NMR spectrum, see 1) J. A. Ewen, CATALYTIC POLYMERIZATION OF OLEFINS: PROCEEDINGS OF THE INTERNATIONAL SYMPOSIUM ON FUTURE ASPECTS OF OLEFIN POLYMERIZATION, T. Keii and K. Soga, Eds. (Elsevier, 1986), pp. 271-292; and 2) U.S. Patent Application US2004/054086 (paragraphs [0043] to [0054]).

The propylene-based elastomer generally has a heat of fusion of about 65 J/g or less, or about 60 J/g or less, or about 50 J/g or less, or about 40 J/g or less. The propylene-based elastomer may have a lower limit H_{f} of about 0.5 J/g, or about 1 J/g, or about 5 J/g. For example, the H_{f} value may range from a lower limit of about 1.0, 1.5, 3.0, 4.0, 6.0, or 7.0 J/g, to an upper limit of about 35, 40, 50, 60, or 65 J/g.

The propylene-based elastomer may have a percent crystallinity, as determined according to ASTM D3418 with a 10° C./min heating/cooling rate, of about 2 to about 65%, or about 0.5 to about 40%, or about 1 to about 30%, or about 5 to about 35%, of the crystallinity of isotactic polypropylene. The thermal energy for the highest order of propylene (i.e., 100% crystallinity) is estimated at 189 J/g. In some embodiments, the copolymer has crystallinity less than 40%, or in the range of about 0.25 to about 25%, or in the range of about 0.5 to about 22%, of the crystallinity of isotactic polypropylene.

In any embodiment, the propylene-based elastomer may have a tacticity index [m/r] from a lower limit of about 4, or about 6, to an upper limit of about 8, or about 10, or about 12. Often, the propylene-based elastomer has an isotacticity index greater than 0%, or within the range having an upper limit of about 50%, or about 25%, and a lower limit of about 3%, or about 10%. The tacticity index is calculated as defined in H. N. Cheng, Macromolecules, 17, 1950 (1984). When [m/r] is 0 to less than 1.0, the polymer is generally described as syndiotactic, when [m/r] is 1.0, the polymer is atactic, and when [m/r] is greater than 1.0, the polymer is generally described as isotactic.

Often, the propylene-based elastomer may further comprise diene-derived units (as used herein, “diene”). The optional diene may be any hydrocarbon structure having at least two unsaturated bonds wherein at least one of the unsaturated bonds is readily incorporated into a polymer. For example, the optional diene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkylene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of diene-derived units present in the propylene-based elastomer may range from an upper limit of about 15%, about 10%, about 7%, about 5%, about 4.5%, about 3%, about 2.5%, or about 1.5%, to a lower limit of about 0%, about 0.1%, about 0.2%, about 0.3%, about 0.5%, about 1%, about 3%, or about 5%, based on the total weight of the propylene-based elastomer.

For purposes of this disclosure, Tₘ of the propylene-based elastomer is determined by ASTM D3418 with a 10° C./min heating/cooling rate. The propylene-based elastomer may have a single peak melting transition. Often, the copolymer has a primary peak transition of about 90° C. or less, with a broad end-of-melt transition of about 110° C. or greater. However, the copolymer may show secondary melting peaks adjacent to the principal peak, and/or at the end-of-melt transition. For the purposes of this disclosure, such secondary melting peaks are considered together as a single melting point, with the highest of these peaks being considered the Tₘ of the propylene-based elastomer. The propylene-based elastomer may have a Tₘ of about 115° C. or less, about 110° C. or less, about 105° C. or less, about 100° C. or less, about 90° C. or less, about 80° C. or less, or about 70° C. or less. Often, the propylene-based elastomer has a Tₘ of about 25 to about 115° C., or about 40 to about 110° C., or about 60 to about 105° C.

The propylene-based elastomer may have a density of about 0.850 to about 0.900 g/cm³, or about 0.860 to about 0.880 g/cm³, at room temperature as measured based on ASTM D1505.

The propylene-based elastomer may have a fractional melt mass-flow rate (MFR), as measured based on ASTM D1238, 2.16 kg at 230° C., of at least about 0.5 g/10 min. In some embodiments, the propylene-based elastomer may have a fractional MFR of about 0.5 to about 50 g/10 min, or about 2 to about 18 g/10 min. The propylene-based elastomer may have an Elongation at Break of less than about 2000%, less than about 1800%, less than about 1500%, or less than about 1000%, as measured based on ASTM D638.

The propylene-based elastomer may have an Mw of about 5,000 to about 5,000,000 g/mol, or about 10,000 to about 1,000,000 g/mol, or about 50,000 to about 400,000 g/mol. The propylene-based elastomer may have an Mn of about 2,500 to about 250,000 g/mol, or about 10,000 to about 250,000 g/mol, or about 25,000 to about 250,000 g/mol. The propylene-based elastomer may have a an Mz of about 10,000 to about 7,000,000 g/mol, or about 80,000 to about 700,000 g/mol, or about 100,000 to about 500,000 g/mol. The propylene-based elastomer may have an Mw/Mn of about 1.5 to about 20, or about 1.5 to about 15, or about 1.5 to about 5, or about 1.8 to about 3, or about 1.8 to about 2.5.

Suitable propylene-based elastomers may be available commercially under the trade names VISTAMAXX™ (ExxonMobil Chemical Company, Houston, Tex., USA), VERSIFY™ (The Dow Chemical Company, Midland, Mich., USA), certain grades of TAFMER™ XM or NOTIO™ (Mitsui Company, Japan), and certain grades of SOFTEL™ (Basell Polyolefins, Netherlands). The particular grade(s) of commercially available propylene-based elastomer suitable for use in the invention can be readily determined using methods commonly known in the art.

### Additives

Optionally, additional additives may be present in the polymer composition of any layer of the multilayer films that are known in the art for modifying the polymer composition to provide particular physical characteristics or effects. The use of appropriate additives is well within the skill of one in the art. Examples of such additives include slipper additive, antiblocking additive (e.g., silica), colored pigments, UV stabilizers, antioxidants, light stabilizers, flame retardants, antistatic agents, biocides, viscosity-breaking agents, impact modifiers, plasticizers, fillers, reinforcing agents, lubricants, mold release agents, blowing agents, pearlizers, and the like. Such additives may comprise from about 0.01% to about 10% by weight based on the total weight of the polymer composition of the layer. Alternatively, additives may be absent or substantially absent from the polymer composition of any layer. For instance, additives may comprise less than 1.0%, or less than 0.5%, or less than 0.1% by weight based on the total weight of the polymer composition of the layer.

### Layer Compositions

Generally, the multilayer films of the present invention are comprised of at least one A layer in combination with at least one B layer and/or at least one C layer. Preferably, the films are comprised of at least one A layer, at least one B layer, and optionally at least one C layer. The A layer can comprise (or consist of, or consist essentially of) and/or be formed from a first layer composition comprising (or consisting of, or consisting essentially of) a propylene polymer and a hydrocarbon resin. Additionally or alternatively, propylene-based elastomer is absent or substantially absent in the first layer composition and/or the A layer. For example, the first layer composition and/or the A layer can comprise less than 30 wt %, or less than 20 wt %, or less than 10 wt %, or less than 5 wt %, or less than 1 wt % of propylene-based elastomer. When the multilayer film comprises two or more A layers, the propylene polymer and/or hydrocarbon resin in each A layer can be the same or different from one another. Further, two or more propylene polymers and/or hydrocarbon resins can be combined and used in each first layer composition. The B layer can comprise (or consist of, or consist essentially of) and/or be formed from a second layer composition comprising (or consisting of, or consisting essentially of) a propylene-based elastomer, and optionally an additional thermoplastic polymer, for example, a propylene polymer. Additionally or alternatively, an additional thermoplastic polymer, for example a propylene polymer, is absent or substantially absent in the second layer composition and/or the B layer. For example, the second layer composition and/or the B layer can comprise less than 30 wt %, or less than 20 wt %, or less than 10 wt %, or less than 5 wt %, or less than 1 wt % of an additional propylene polymer. Additionally or alternatively, hydrocarbon resin is absent or substantially absent in the second layer composition and/or the B layer. For example, the second layer composition and/or the B layer can comprise less than 30 wt %, or less than 20 wt %, or less than 10 wt %, or less than 5 wt %, or less than 1 wt % of a hydrocarbon resin. When the multilayer film comprises two or more B layers, the propylene-based elastomer and optional thermoplastic polymer in each B layer can be the same or different from one another. Further, two or more propylene-based elastomers and optionally two or more thermoplastic polymers can be combined and used in each second layer composition. The C layer can comprise (or consist of, or consist essentially of) and/or be formed from a third layer composition comprising (or consisting of, or consisting essentially of) a propylene polymer. Additionally or alternatively, hydrocarbon resin and/or propylene-based elastomer is absent or substantially absent in the third layer composition and/or the C layer. For example, the third layer composition and/or the C layer can comprise less than 30 wt %, or less than 20 wt %, or less than 10 wt %, or less than 5 wt %, or less than 1 wt % of hydrocarbon resin and/or propylene-based elastomer. When the multilayer film comprises two or more C layers, the propylene polymer in each C layer can be the same or different from one another. Further, two or more propylene polymers can be used in each third layer composition.

In any embodiment, the A layer and/or the first layer composition can comprise at least about 50 wt % of the propylene polymer and not greater than about 50 wt % of the hydrocarbon resin. For example, the A layer and/or the first layer composition can comprise from a lower limit of about 50 wt %, 55 wt %, 60 wt %, 65 wt %, 70 wt %, 75 wt %, 80 wt %, 85 wt %, 90 wt %, 95 wt % to an upper limit of from about 99 wt %, 95 wt %, 90 wt %, 85 wt %, 80 wt %, 75 wt %, 70 wt %, 65 wt %, 60 wt %, or 55 wt % of the propylene polymer, based on total weight of the A layer and/or the first layer composition. Preferably, the amount of the propylene polymer(s) in the A layer and/or the first layer composition of the multilayer film is from about 50 wt % to about 99 wt %, from about 50 wt % to about 95 wt %, from about 65 wt % to about 95 wt %, or from about 65 wt % to about 90 wt %, or any ranges between the above described lower limit and upper limit values so long as the lower limit value is less than the upper limit value. The A layer and/or the first layer composition can comprise from a lower limit of about 1 wt %, 5 wt %, 8 wt %, 10 wt %, 12 wt %, 15 wt %, 20 wt %, 25 wt %, or 30 wt % to an upper limit of from 50 wt %, 45 wt %, 40 wt %, 35 wt %, 30 wt %, 25 wt %, 20 wt %, or 15 wt % of the hydrocarbon resin(s), based on the total weight of the A layer and/or the first layer composition. Preferably, the amount of the hydrocarbon resin(s) in the A layer and/or the first layer composition of the multilayer film is from about 1 to about 50 wt %, from about 1 to about 35 wt %, from about 5 wt % to about 35 wt %, from about 10 wt % to about 35 wt %, from about 10 wt % to about 30 wt %, of from about 12 wt % to about 30 wt %, or from about 12 wt % to about 25 wt %, or any ranges between the above described lower limit and upper limit values so long as the lower limit value is less than the upper limit value.

In any embodiment, the B layer and/or the second layer composition can comprise from at least about 10 wt %, 20 wt %, 30 wt %, 40 wt %, 50 wt %, 60 wt %, 70 wt %, 80 wt %, 90 wt %, or 100 wt % of the propylene-based elastomers by weight of the B layer and/or the second layer composition, and optionally comprise the propylene polymer(s) described herein in an amount of less than about 90 wt %, 80 wt %, 70 wt %, 60 wt %, 50 wt %, 40 wt %, 30 wt %, 20 wt %, or 10 wt %. Preferably, the B layer may consist of 100 wt % of the propylene-based elastomer(s).

In any embodiment, the C layer and/or the third layer composition can comprise from at least 20 wt %, 30 wt %, 40 wt %, 50 wt %, 60 wt %, 70 wt %, 80 wt %, 90 wt %, or 100 wt % of the propylene polymer(s) described herein. Preferably, the C layer may consist of 100 wt % of the propylene polymer(s).

Additives may be optionally present in the A layer, the B layer, and/or the C layer in an amount of less than 10 wt %, or 8 wt %, or 5 wt %, or 3 wt %, or 2 wt %, or 1 wt %, or 0.5 wt %, or 0.1 wt % based on the weight of the layer or the polymer composition used to form the layer. For example, a nucleating agent may often be present in the A layer. Additionally, a slipper additive and/or an antiblocking additive may often be present in the B layer.

### Film Structures

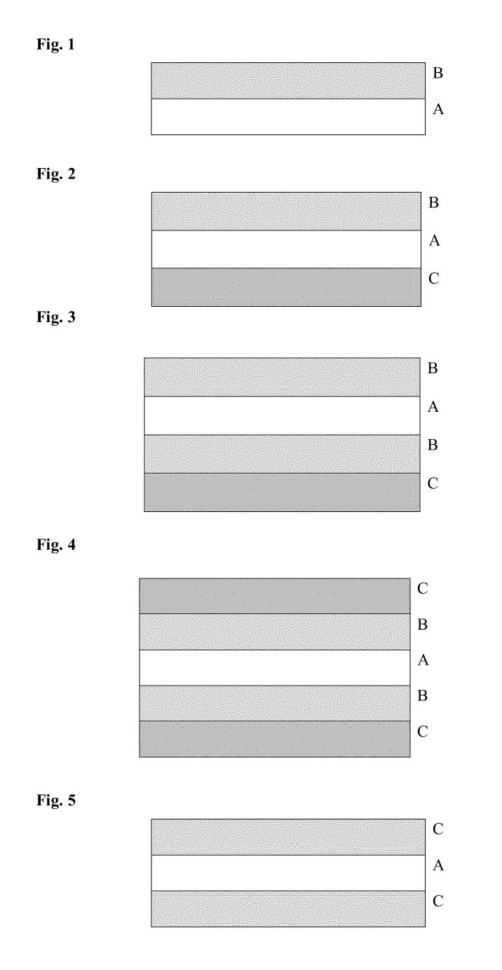

The multilayer films of the present invention generally comprise a first layer (A layer) and at least one of a second layer (B layer) and a third layer (C Layer). Preferably, the films comprise an A layer and a B layer, i.e., an A/B lamination as shown in FIG. 1. Preferably, the multilayer films further comprise at least one third layer (C layer). Preferred lamination structures of the multilayer films are described in the following illustrated structures. The invention is not limited to these illustrated structures, and this description is not meant to foreclose other aspects within the broader scope of the invention.

Often, the multilayer film comprises an odd number of layers, preferably three layers or five layers.

Preferably, the multilayer film may comprise one A layer, one B layer joined on one surface of the A layer, and one C layer joined on the other surface of the A layer, i.e., a B/A/C structure as shown in FIG. 2.

Alternatively, the multilayer film may comprise one A layer, two B layers each joined on one surface of the A layer, and a C layer joined on one of the two B layers, i.e., a B/A/B/C structure as shown in FIG. 3. The two B layers can be the same or different (i.e., B and B′).

Alternatively, the multilayer film may comprise one A layer, two B layers each joined on one surface of the A layer, and two C layers each joined on one B layer, i.e., a C/B/A/B/C structure as shown in FIG. 4. The two B layers can be the same or different (i.e., B and B′), and the two C layers can be the same or different (i.e., C and C′) as well.

Yet alternatively, the multilayer film may comprise one A layer and two C layers joined on the two surfaces of the A layer, i.e., a C/A/C structure as shown in FIG. 5.

Generally, any of the foregoing described film layer(s) may be added to the A layer and/or to the at least one B layer joined on the A layer, depending on the desired film application. For example, the multilayer films can comprise other layer lamination structures, such as B/A/C/B, B/A/C/B′, C/B/A/C, C/B/A/C′, B/A/C/B/C′, B/A/C/B′/C, B/A/C/B′/C′, B/A/B/A′/C, B/A/B′/A/C, B/A/B′/A′/C, C/B/A/B′/A′/C′, C/B/A/B/A′/C′, C/B/A/B′/A/C′, C/B/A/B′/A′/C, C/B/A/B′/A′/C′, etc.

The present multilayer films can optionally comprise an additional layer(s) (i.e., “D layer(s)”) other than the A layer, the B layer, and the C layer. The additional D layers can comprise and/or be formed from polyolefins and materials other than propylene polymers, such as paper, wood, cardboard, metal, metal foils (such as aluminum foil and tin foil), metallized surfaces, glass (including silicon oxide (SiOₓ) coatings applied by evaporating silicon oxide onto a film surface), fabric, spunbond fibers, and non-wovens, and substrates coated with inks, dyes, pigments, and the like. Examples of film structures of D-containing multilayer films include B/A/D, B/A/C/D, D/B/A/B′/C, B/A/B′/C/D, D/C/B/A/B′/C′, C/B/A/B′/C′/D, or the like.

Generally, the thickness of the multilayer films may range from about 10 to about 200 μm and is mainly determined by the intended use and properties of the film. The present films may be thin, e.g., for application in easy-tear plastic bags, or can be much thicker, e.g., for applications in heavy duty bags. Conveniently, the multilayer films described herein have a thickness of from about 10 to about 200 μm, from about 20 to about 150 μm, or from about 30 to about 130 μm. Desirably, a film thickness not exceeding 100 μm, preferably not exceeding 60 μm, preferably from about 20 to about 50 μm, may be well suited to easy-tear films, while a thickness varying within a range between higher end values, preferably from about 50 to about 130 μm, may be well suited for sealing films.

Preferably, the A layer has a thickness of at least about one third, for example, about one third, about two fifths, about half, about three fifths, about two thirds, about four fifths, or in the range of any combination of the values recited herein, of the total thickness of the multilayer film. Alternatively or additionally, the thickness ratio between the A layer and the B layer is about (0.5-5): 1, for example, from about 1:1 to about 4:1, such as, about 0.5:1, 1:1, about 1.5:1, about 2:1, about 2.5:1, about 3:1, about 3.5:1, or about 4:1. The thickness of the C layer(s) can be determined based on the actual needs of desired application, for example, the thickness of the C layer(s) can be one fifth, one fourth, two fifths of the total thickness of the multilayer film, but usually not more than one half of the total thickness of the multilayer film.

### Methods of Making the Multilayer Film

The multilayer films described herein may be formed by any of the conventional techniques known in the art. Illustrative methods include blown extrusion, cast extrusion, and co-extrusion.

Preferably, the multilayer films of the present invention are formed by using cast extrusion techniques, i.e., to form a cast film. For example, the multilayer film structure maybe formed by coextruding the core layer together with the heat sealable layer and functional layer through a flat sheet extruder die at a temperature ranging from between about 200° C. to about 270° C., casting the multi-layer film onto a cooling drum and quenching the multilayer film. The chilling temperature of the cooling drum can be controlled by cooling water having a temperature of from about 0° C. to about 40° C.

In one aspect, the present invention provides a method of lowering the sealing initiation temperature of a multilayer film, the method comprises using a polymer blend in a first layer of the multilayer film, such polymer blend comprises from 1 wt % to 50 wt %, preferably from 10 wt % to 30 wt % of a hydrocarbon resin as described herein and from 50 wt % to 99 wt % of a propylene polymer as described herein based on the weight of the polymer blend.

### Properties and Applications of the Multilayer Film

Preferably, the multilayer films of the present invention are unoriented. Ideally, the multilayer films are cast films.

Often, the multilayer films have an SIT of less than about 105° C., or less than about 100° C., or less than 90° C., or less than 80° C., or less than 70° C., or less than 65° C.

Often, the multilayer films have a TD Elmendorf tear strength measured according to ASTM D1922 of less than 3.0 g/μm, or less than 2.5 g/μm, or less than 2.0 g/μm, or less than 1.8 g/μm, or less than 1.5 g/um.

Alternatively or additionally, the multilayer films can have an MD 1% secant modulus measured according to ASTM D882 of greater than about 750 MPa, or greater than 800 MPa, or greater than 850 MPa, or greater than about 900 MPa, or greater than about 1000 MPa.

Alternatively or additionally, the multilayer films can have a puncture resistance force as measured using a method based on ASTM D5748 of greater than about 30 N, or greater than about 1.0 N/μm. The method for measuring puncture resistance force proceeds with a film sample that is fastened in a sample specimen holder. A penetration probe made of hardened steel with rounded tip (19 mm diameter) is pushed through the film sample at a constant test speed (254 mm/min). The force is measured by a load cell and the deformation of the film sample is measured by the travel of the cross-head.

Alternatively or additionally, the multilayer films can have a Haze % measured according to ASTM D1003 Procedure A of less than 6%, less than 5%, less than 4%, less than 3%, or less than 2.5%.

Preferably, the multilayer films have a combination of the aforementioned properties. For example, the multilayer films preferably have an SIT of less than about 105° C. and a TD Elmendorf tear strength measured according to ASTM D1922 of less than 3.0 Wm. More preferably, the multilayer films have an SIT of less than about 105° C., a TD Elmendorf tear strength measured according to ASTM D1922 of less than 3.0 g/μm, an MD 1% secant modulus measured according to ASTM D882 of greater than about 750 MPa, a puncture resistance force as measured using a method based on ASTM D5748 of greater than about 30 N, and a Haze % measured according to ASTM D1003 Procedure A of less than 6%.

The multilayer films described herein can be used for any purpose, but are particularly suited to packaging, in particular to food packaging applications. The multilayer films described herein can display outstanding properties as demonstrated by sealing initiation temperature, sealing strength, tear strength, tensile strength, resistance to puncture and elongation at break, and clarity, which are important for packaging applications.

In one aspect, the present inventive films are particularly suitable for temperature-sensitive food packing application in view of the lowered sealing initiation temperature. In another aspect, the present inventive films are suitable in application where high film stiffness, which can be indicated by a high 1% secant modulus, is particularly required. In still another aspect, the present inventive films are suitable useful in applications where easy-tear performance, which can be indicated by a low TD Elmendorf tear strength, is sought. Other packaging applications can also be used depending on desired properties.

### EXAMPLES

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

Therefore, the following examples are put forth so as to provide those skilled in the art with a complete disclosure and description and are not intended to limit the scope of that which the inventors regard as their invention.

### Testing Methods

Sealing strength was measured based on ASTM F 88. For examples 1-3, example 10, comparative example 1, and comparative example 4, the seal strength was measured using an Hot Tack Test with a seal pressure of 0.5 MPa and a seal/dwell time of 0.5 second, and a peel speed of 500 mm/min. For other examples and comparative examples, the seal strength was measured using an RDM Heat Sealer, Model HSX-1 using a seal pressure of 0.2 MPa and a seal/dwell time of 0.5 second, and a peel speed of 508 mm/min (20 inches/min). Seal strength values correspond to the “F-max” maximum values.

1% Secant modulus, elongation at break, and tensile strength were measured based on the method of ASTM D882 for examples 1-3, example 10, comparative example 1, and comparative example 4 and according to the method of ASTM D882 for all other examples and comparative examples. The puncture force for examples 1-3 and comparative example 1 were measured based on the method of ASTM D5748 on a Zwick Z010 testing machine. For other examples and comparative examples, puncture resistance was measured based on the method of ASTM D5748 using a United “SFM-I” testing machine as follows. 15.24 centimeter wide samples were cut and gauged for thickness, after which each film sample was fastened in a sample specimen holder. A penetration probe made of hardened steel with rounded tip (19 mm diameter) was pushed through the film sample at a constant test speed (254 mm/min). The force was measured by a load cell and the deformation of the film sample was measured by the travel of the cross-head. The average peak load and break energy values of five specimens for each film sample tested were used to compile the final test results.

Elmendorf tear strength values for examples 1-3, example 10, comparative example 1, and comparative example 4 were measured based on the method of ASTM D1922 and according to the method of ASTM D1922 for all other examples and comparative examples.

Water Vapor Transmission Rate (WVTR) was measured according to ASTM F1249 at 38° C. and a humidity of about 90% RH.

Haze % values for examples 1-3, example 10, comparative example 1, and comparative example 4 were measured based on the method of ASTM D1003 Procedure A and according to the method of ASTM D1003 Procedure A for all other examples and comparative examples.

### Materials

PP4712E1 (“PP1”) is a homopolypropylene having a density of 0.900 g/cm³ and an MFR (2.16 kg @ 230° C., ASTM D-1238) of 2.8 g/10 min, commercially available from ExxonMobil Chemical Company, TX.

PP9513 (“PP2”) is a propylene random copolymer comprising about 2.8 wt % ethylene and having a density of 0.900 g/cm³ and an MFR (2.16 kg @ 230° C., ASTM D-1238) of 7.3 g/10 min, commercially available from ExxonMobil Chemical Company, TX.

FC801 (“PP3”) is a homopolypropylene having an MFR (2.16 kg @ 230° C., ASTM D-1238) of 8.0±2.0 g/10 min., commercially available from Sinopec, China.

F800E (“PP4”) is a random copolymer of propylene and ethylene having an MFR (2.16 kg @ 230° C., ASTM D-1238) of 8.0±2.5 g/10 min, commercially available from Sinopec, China.

COSMOPLENE™ FL7540L (“PP5”) is polypropylene terpolymer product having an MFR (2.16 kg @ 230° C., ASTM D-1238) of 7 g/10 min, commercially available from The Polyolefin Company (Singapore) Pte Ltd.

POLYBATCH™ SPR6 (“SMB”) is a slipper additive commercially available from A. Schulman, OH.

POLYBATCH™ ABPP05 SC MED (“ABMB”) is an antiblocking additive commercially available from A. Schulman, OH.

Oppera™ PR 100A (“HCR”) resin is an amorphous cyclic olefin oligomer hydrocarbon resin available from ExxonMobil Chemical Company, TX.

MA00930PP (“HMB”) is a masterbatch containing homopolypropylene having an MFR of 3 g/10 min (2.16 kg @ 230° C., ASTM D-1238) and 60 wt % of hydrocarbon resins under tradename Oppera™ PR100N available from ExxonMobil Chemical Company, TX; the masterbatch is commercially available from Constab Polyolefin Additives GmbH, Germany.

Vistamaxx™ 3588 polymer (“PBE1”) is a propylene-based elastomer having about 4 wt % of ethylene-derived units with the remaining of propylene-derived units, and having a vicat softening temperature 103° C., a density of about 0.889 g/cm³, and an MFR (230° C., 2.16 kg) of about 8.0 g/10 min, and is commercially available from ExxonMobil Chemical Company, TX.

Vistamaxx™ 3020 FL polymer (“PBE2”) is a propylene-based elastomer having about 11 wt % of ethylene-derived units with the remaining of propylene-derived units, and having a vicat softening temperature 68.3° C., a density of about 0.874 g/cm3, and an MFR (230° C., 2.16 kg) of about 3.0 g/10 min, and is commercially available from ExxonMobil Chemical Company, TX.

### Comparative Example 1; Comparative Example 4; Examples 1-3; and Example 10

Three-layer cast films having a B/A/C structure having differing amounts of hydrocarbon resin in the A layer were fabricated in a cast film line in example 1 to 3 (Ex. 1-3). A comparative example 1 (Cx. 1) having the same structure as Ex. 1-3 but containing no hydrocarbon resin in the A layer was also fabricated in the cast film line. A three-layer cast film having a C/A/C structure, wherein one of the C layers comprised a polypropylene terpolymer, was fabricated in the cast film line in example 10 (Ex. 10). A comparative example 4 (Cx. 4) having the same structure as Ex. 10 but containing no hydrocarbon resin in the A layer was also fabricated in the cast film line. The cast film line had three extruders 90/125/90 mm each having an L/D ratio of 32:1, which fed polymer into a feedblock. The feedblock diverted molten polymer from the extruder to a die having a width of 2.5 m. The molten polymer exited the die at a temperature of 250° C. and was cast on a chill roll at 30° C. The casting unit was equipped with adjustable winding speeds to obtain film having the targeted thickness. The film structure, layer composition, film thickness, and thickness ratios between layers for each example and comparative example film are shown in Table 1. The fabricated three-layer films were stabilized for 1 month and conditioned for 40 h under 23° C., 50% humidity and measured for properties according to the methods described herein. Results are shown in Tables 1 and 2.

### Comparative Examples 2 and 3 and Examples 4-9

Three-layer cast films having a B/A/C and C/A/C structure were fabricated in comparative examples 2 and 3 (Cx. 2 and Cx. 3), and Examples 4 and 7 (Ex. 4 and Ex. 7) in a Killion cast line. This Killion line had three extruders each having an L/D ratio of 24:1 and a diameter of 2.54 cm, which fed polymer into a feedblock. The feedblock diverted molten polymer from the extruder to Cloeren die having a width of 20.32 cm. Molten polymer exited the die at a temperature of 230° C. and was cast on a chill roll (20.3 cm diameter, 25.4 cm roll face) at 21° C.

Five-layer cast films having a CBABC structure were fabricated in examples 5-6 and 8-9 (Ex. 5-6, and Ex. 8-9) in the above Killion line by use of a CBABC selector plug.

The casting unit was equipped with adjustable winding speeds to obtain film having the targeted thickness. The film structure, layer composition, film thickness, and thickness ratios between layers for each example and comparative example film are shown in Table 1. The fabricated films were measured after aged for about five weeks for properties according to the methods described herein. Results are shown in Tables 1 and 2.

It can be seen from examples 1 to 4, 7, and 10 that a BAC or CAC multilayer film having an A layer comprising hydrocarbon resin in addition to propylene polymer exhibited an increased 1% secant modulus (indicating improved stiffness), an increased clarity, improved barrier property, and a decreased TD Elmendorf tear strength (indicating improved easy-tear performance) as compared to a multilayer film having the same BAC or CAC film structure but not comprising the hydrocarbon resin in the A layer, as shown in comparative examples 1 to 4. These improvements demonstrated by the inventive films are particularly useful in certain easy-opening packing applications.

Furthermore, it can be seen from Tables 1 and 2 that the present inventive films comprising an A layer containing propylene polymers and hydrocarbon resins and a B layer containing propylene-based elastomers, as shown in examples 1 to 3, 5 to 6, and 8 to 9, provided significantly lowered sealing initiation temperatures compared to films that did not comprise the A layer and the B layer, as shown in comparative examples 1, and examples 4 and 7. In addition to providing significantly lowered sealing initiation temperatures, Tables 1 and 2 illustrate that the inventive films of examples 1 to 3, 5 to 6, and 8 to 9 maintained comparable toughness and stiffness to the films of comparative examples 1 and examples 4 and 7.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. For example, the compositions described herein may be free of any component, or composition not expressly recited or disclosed herein. Any method may lack any step not recited or disclosed herein. Likewise, the term “comprising” is considered synonymous with the term “including.” And whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

TABLE 1
Composition, structures and properties of multilayer films

| Example | Cx. 1 | Ex. 1 | Ex. 2 | Ex. 3 | Cx. 2 | Ex. 4 | Ex. 5 |
|---|---|---|---|---|---|---|---|
| Thickness (μm) | 34 | 34 | 34 | 34 | 49 | 47 | 44 |
| Thickness ratios | B:A:C = 11: | B:A:C = | B:A:C = | B:A:C = | C:A:C = | C:A:C = | C:B:A:B:C = |
| | 3:1 | 1:3:1 | 1:3:1 | 1:3:1 | 1:1:1 | 1:2:1 | 1:4:10:4:1 |
| C layer | — | — | — | — | PP-1 | PP-1 | PP-1 |
| | | | | | (100 wt %) | (100 wt %) | (100 wt %) |
| B layer | PBE1 | PBE1 | PBE1 | PBE1 | — | — | PBE2 |
| | (93.33 | (93.33 | (93.33 | (93.33 | | | (100 wt %) |
| | wt %) + | wt %) + | wt %) + | wt %) + | | | |
| | SMB (1.67 | SMB(1.67 | SMB (1.67 | SMB (1.67 | | | |
| | wt %) + | wt %) + | wt %) + | wt %) + | | | |
| | ABMB(5 | ABMB(5 | ABMB(5 | ABMB(5 | | | |
| | wt %) | wt %) | wt %) | wt %) | | | |
| A layer | PP3 | PP3 (83 | PP3 (75 | PP3 (67 | PP-1 | PP1 (85 | PP1 (85 |
| | (100 wt %) | wt %) + | wt %) + | wt %) + | (100 wt %) | wt %) | wt %) + |
| | | HMB(17 | HMB (25 | HMB (33 | | + | HCR* (15 |
| | | wt %) | wt %) | wt %) | | HCR* (15 | wt %)* |
| | | | | | | wt %) | |
| B layer | — | — | — | — | — | — | PBE-2 |
| | | | | | | | (100 wt %) |
| C layer | -PP4 | -PP4 | -PP4 | -PP4 | -PP-1 | -PP1 | PP1 |
| | (100 wt %) | (100 wt %) | (100 wt %) | (100 wt %) | (100 wt %) | (100 wt %) | (100 wt %) |
| Sealing Initiation | 110 | 90 | 90 | 90 | 110 | 120 | 60 |
| Temperature (° C.) | | | | | | | |
| 1% MD Secant Modulus | 748 | 1041 | 1088 | 1173 | 851 | 1131 | 938 |
| (MPa) | | | | | | | |
| 1% TD Secant Modulus | 819 | 1012 | 1004 | 1206 | 833 | 1066 | 742 |
| (MPa) | | | | | | | |
| Puncture Force (N) | 33.3 | 36.8 | 34.2 | 39.5 | 30.5 | 28.7 | 71.3 |
| Elmendorf MD tear | 1.6 | <1.2 | <1.2 | <1.2 | 1.37 | 0.8 | 0.1 |
| strength (g/μm) | | | | | | | |
| Elmendorf TD tear | 3.3 | 1.5 | 1.5 | <1.2 | 12.68 | 2.9 | 11.7 |
| strength (g/μm) | | | | | | | |
| MD Elongation at Break | 647 | 564 | 628 | 230 | 669 | 6.8 | 436 |
| (%) | | | | | | | |
| TD Elongation at Break | 709 | 704 | 645 | 127 | 716 | NA | 5 |
| (%) | | | | | | | |
| Tensile Strength MD | 61 | 51.4 | 61.8 | 37.7 | 74 | 69 | 71 |
| (MPa) | | | | | | | |
| Tensile Strength TD (MPa | 43.1 | 42.5 | 37.3 | 19.5 | 44 | 29 | 14 |
| Haze (%) | 7.7 | 4.3 | 4.0 | 4.1 | 4 | 3.4 | 2.3 |
| WVTR (gm − mil/m² | 15.33 | 11.90 | 11.65 | 9.84 | 12.7 | 9.3 | 14.9 |
| per day) | | | | | | | |

Composition, structures and properties of multilayer films

| Example | Ex. 6 | Cx. 3 | Ex. 7 | Ex. 8 | Ex. 9 | Cx. 4 | Ex. 10 |
|---|---|---|---|---|---|---|---|
| Thickness (μm) | 40 | 55 | 58 | 43 | 57 | 34 | 34 |
| Thickness ratios | C:B:A:B:C = | C:A:C = | CA:C = | C:B:A:B:C = | C:B:A:B:C = | C:A:C = | C:A:C = |
| | 1:4:10:4:1 | 1:1:1 | 1:2:1 | 1:4:10:4:1 | 1:4:10:4:1 | 1:3:1 | 1:3:1 |
| C layer | PP-1 | PP-2 | -PP-2 | PP-2 | PP-2 | PP5 (93.33 | PP5 (93.33 |
| | (100 wt %) | (100 wt %) | (100 wt %) | (100 wt %) | (100 wt %) | wt %) + | wt %) + |
| | | | | | | SMB (1.67 | SMB (1.67 |
| | | | | | | wt %) | wt %) |
| B layer | PBE2 | — | — | PBE2 | PBE2 | — | — |
| | (100 wt %) | | | (100 wt %) | (100 wt %) | | |
| A layer | PP1 (70 | PP-2 | PP2 (75 | PP1 | PP1 (10 | PP3 | PP3 (83 |
| | wt %) + | (100 wt %) | wt %) + | (20 wt %) + | wt %) + | (100 wt %) | wt %) + |
| | HCR* (30 | | PP1(l0 wt | PP2 | PP2 | | HMB(17 |
| | wt %) | | % | (50 wt %) + | (75 wt %) + | | wt %) |
| | | | HCR* (15 | HCR* (30 | HCR* (15 | | |
| | | | wt %)* | wt %)* | wt %)* | | |
| B layer | PBE-2 | — | — | PBE2 | PBE2 | — | — |
| | (100 wt %) | | | (100 wt %) | (100 wt %) | | |
| C layer | PP1 | PP-2 | -PP2 | PP2 | PP2 | PP4 | PP4 |
| | (100 wt %) | (100 wt %) | (100 wt %) | (100 wt %) | (100 wt %) | (100 wt %) | (100 wt %) |
| Sealing Initiation | 60 | 120 | 120 | 70 | 65 | 115 | 115 |
| Temperature (° C.) | | | | | | | |
| 1% MD Secant Modulus | 676 | 605 | 765 | 853 | 368 | 854 | 1147 |
| (MPa) | | | | | | | |
| 1% TD Secant Modulus | 484 | N/M | N/M | N/M | N/M | 869 | 1108 |
| (MPa) | | | | | | | |
| Puncture Force (N) | 32.8 | 34.4 | 37.7 | 38.6 | 30.6 | 28.3 | 29.5 |
| Elmendorf MD tear | 0.6 | 0.97 | 0.72 | 0.14 | 0.38 | <1.2 | <1.2 |
| strength (g/μm) | | | | | | | |
| Elmendorf TD tear | 26.95 | 5.64 | 1.77 | 3.97 | 18.05 | 3.3 | 1.6 |
| strength (g/μm) | | | | | | | |
| MD Elongation at Break | 536 | 682 | 710 | 301 | 338 | 603 | 563 |
| (%) | | | | | | | |
| TD Elongation at Break | 385 | 748 | 7 | 3. | 370 | 698 | 654 |
| (%) | | | | | | | |
| Tensile Strength MD | 59 | 64 | 63 | 64 | 45 | 60.8 | 53.5 |
| (MPa) | | | | | | | |
| Tensile Strength TD (MPa | 23 | 46 | 26 | 16 | 12 | 45 | 38.1 |
| Haze (%) | 1.8 | 4.7 | 6 | 5.8 | 13.7 | 4.8 | 4 |
| WVTR (gm − mil/m² | 15.4 | 15.9 | 12.1 | 18.2 | 26.8 | 14.97 | 10.8 |
| per day) | | | | | | | |

*added through a masterbatch comprising 60% of PP1 and 40% of HCR.

TABLE 2
Sealing temperature and sealing strength of multilayer films

| | Cx. 1 | Ex. 1 | Ex. 2 | Ex. 3 | Cx. 2 | Ex. 4 | Ex. 5 | Ex. 6 | Cx. 3 | Ex. 7 | Ex. 8 | Ex. 9 | CX. 4 | EX. 10 |
|---|---|---|---|---|---|---|---|---|---|---|---|---|---|---|
| Sealing | Seal | Seal | Seal | Seal | Seal | Seal | Seal | Seal | Seal | Seal | Seal | Seal | Seal | Seal |
| Tem- | strength | strength | strength | strength | strength | strength | strength | strength | strength | strength | strength | strength | strength | strength |
| per- | (N/15 | (N/15 | (N/15 | (N/15 | (N/15 | (N/15 | (N/15 | (N/15 | (lbs) | (lbs) | (lbs) | (lbs) | (N/15 | (N/15 |
| ature | mm) | mm) | mm) | mm) | mm) | mm) | mm) | mm) | | | | | mm) | mm) |
| (° C.) | | | | | | | | | | | | | | |
| 60 | | | | | | | 1(P) | 2(P) | | | | | | |
| 65 | | | | | | | N/M | N/M | | | | 029 (P) | | |
| 70 | | | | | | | 9.3(P) | 7.4(P) | | | 0.09(P) | 1.38 (P) | | |
| 75 | | | | | | | N/M | N/M | | | 0.33(P) | 3.26 (B) | | |
| 80 | | | | | | | 12.7(P/ | 8.4(P/ | | | 0.52(P) | 2.78 (B) | | |
| | | | | | | | B) | B) | | | | | | |
| 85 | | | | | | | N/M | N/M | | | 0.97(P) | 3.88 (B) | | |
| 90 | | 0.3(P) | 0.3(P) | 0.3(P) | | | 13.4(B) | 10.9(B) | | | 0.96(P) | | | |
| 95 | | 1.5(P) | 2.5(P) | 1.4(P) | | | N/M | N/M | | | 1.62(P) | | | |
| 100 | | 11.3(P) | 11.2(P) | 11(P) | | | 15.8(B) | 12.7(B) | | | 0.89(P) | | | |
| 105 | | N/M | N/M | N/M | | | N/M | N/M | | | 1.48(P) | | | |
| 110 | | 14.2(B) | 14.5(B) | 14.5(B) | 0.2(P) | | 17(B) | 14.4(B) | | | 1.86(P) | | | |
| 115 | 0.7(P) | N/M | N/M | N/M | | | | | | | 2.12(P) | | 0.2(P) | 0.2(P) |
| 120 | 13.3(P) | 15.8(B) | 15.1(B) | 16.1(B) | 0.5(P) | 0.4(P) | | | 0.19(P) | 0.08 (P) | 2.38(P) | | 4.7(P) | 4.7(P) |
| 125 | N/M | N/M | N/M | N/M | | N/M | | | 0.53(P) | 0.67(P) | 2.62(P) | | N/M | N/M |
| 130 | 15.2(B) | 16.6(B) | 16.4(B) | 17.0(B) | 0.8(P) | 0.9(P) | | | 3.60(P) | 4.59 (P) | 3.20(P) | | 14.8(B) | 16.8(B) |
| 135 | N/M | N/M | N/M | N/M | | N/M | | | 7.08(B) | 8.50(B) | 3.94(P) | | N/M | N/M |
| 140 | 17.2(B) | 16.3(B) | 15.8(B) | 15.6(B) | 6.7(P) | 3.1(P) | | | 7.39(B) | 9.77(B) | 4.43(P) | | 16.2(B) | 18.5(B) |
| 145 | N/M | | | | | N/M | | | 8.85(B) | 8.11(B) | 4.44(B) | | N/M | N/M |
| 150 | 17.6(B) | | | | 27.1(B) | 21.8(B) | | | | | 5.71(B) | | 17(B) | 22.1(B) |
| 155 | N/M | | | | | N/M | | | | | 4.12(B) | | N/M | N/M |
| 160 | 18.5(B) | | | | 29.3(B) | 23.3(B) | | | | | | | 17.1(B) | 20.1(B) |
| 170 | | | | | 30.5(B) | 27.3(B) | | | | | | | | |

N/M-Not measured;
P-peeling;
B-edge break.

What is claimed is:

1. A multilayer film comprising:
a first layer, A, wherein the first layer comprises from 1 to 50 wt % of a hydrocarbon resin and from 50 to 99 wt % of a propylene polymer,
wherein the propylene polymer is a propylene homopolymer or a copolymer of propylene and at least one comonomer selected from ethylene and C₄-C₂₀ alpha-olefins, wherein the copolymer has a propylene content of at least 80 wt % and has a melting point of greater than 115° C., and
wherein the hydrocarbon resin comprises an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, or a combination thereof; and
a second layer, B, wherein the second layer comprises a propylene-based elastomer,
wherein the propylene-based elastomer comprises propylene and at least one comonomer selected from ethylene and C₄-C₂₀ alpha-olefins, has a propylene content of at least 75 wt %, an mm triad tacticity of greater than 75%, a melting point of less than 115° C., and a heat of fusion of less than 65 J/g.

2. The multilayer film of claim 1, wherein the film further comprises a third layer, C, wherein the third layer comprises a propylene polymer wherein the propylene polymer is a propylene homopolymer or a copolymer of propylene and at least one comonomer selected from ethylene and C₄-C₂₀ alpha-olefins, wherein the copolymer has a propylene content of at least 80 wt % and has a melting point of greater than 115° C.

3. The multilayer film of claim 2, wherein the film has the structure BAC.

4. The multilayer film of claim 3, wherein the propylene polymer of the C layer is substantially the same as the propylene polymer of the A layer.

5. The multilayer film of claim 2, wherein the film has the structure CBAB or CBABC.

6. The multilayer film of claim 5, wherein the propylene-based elastomers of the two B layers are substantially the same.

7. The multilayer film of claim 5, wherein the film has the structure CBABC.

8. The multilayer film of claim 7, wherein the propylene polymers of the two C layers are substantially the same.

9. The multilayer film of claim 1, wherein the B layer further comprises from 10 to 90 wt % of a propylene polymer, wherein the propylene polymer is a propylene homopolymer or a copolymer of propylene and at least one comonomer selected from ethylene and C₄-C₂₀ alpha-olefins, wherein the copolymer has a propylene content of at least 80 wt % and has a melting point of greater than 115° C.

10. The multilayer film of claim 1, wherein the B layer further comprises a slip additive and/or antiblocking additive in an amount of from 0.01 to 10 wt % by the weight of the layer.

11. The multilayer film of claim 1, wherein the propylene-based elastomer has a propylene content of from 80 wt % to 97 wt %, and an ethylene content of from 3 wt % to 20 wt %.

12. The multilayer film of claim 1, wherein the propylene-based elastomer has a propylene content of from 90 wt % to 97 wt %, and an ethylene content of from 3 wt % to 10 wt %.

13. The multilayer film of claim 1, wherein the propylene polymer of each layer is independently selected from a propylene homopolymer or a random copolymer of propylene.

14. The multilayer film of claim 1, wherein the hydrocarbon resin has a total dicyclopentadiene, cyclopentadiene, and methylcyclopentadiene derived content of from about 60 wt % to about 100 wt % of the total weight of the hydrocarbon resin and wherein the hydrocarbon resin has a weight average molecular weight of from about 600 g/mole to about 1400 g/mole.

15. The multilayer film of claim 1, wherein the hydrocarbon resin is present in the A layer from about 5 wt % to about 30 wt % by weight of the A layer.

16. The multilayer film of claim 1, wherein the film is a cast film, a blown film, or a laminated film.

17. The multilayer film of claim 1, wherein the film is a cast film.

18. The multilayer film of claim 1, wherein the thickness of the A layer is from 30% to 70% of the total thickness of the multilayer film.

19. The multilayer film of claim 1, wherein the ratio of the thickness of A:B is (0.5-5):1.

20. The multilayer film of claim 1, wherein the film has a sealing initiation temperature of less than about 105° C., preferably less than about 80° C.

21. The multilayer film of claim 1, wherein the film has an Elmendorf TD tear strength, as determined according to ASTM D1922, of less than about 3.0 g/μm, and an 1% MD Secant Modulus, as determined according to the method of ASTM D882, of greater than 750 MPa.

22. A multilayer film comprising:
a first layer, A, wherein the first layer comprises from 5 to 30 wt % of a hydrocarbon resin and from 70 to 95 wt % of a propylene polymer, wherein the propylene polymer is a propylene homopolymer or a copolymer of propylene and at least one comonomer selected from ethylene and C₄-C₂₀ alpha-olefins, wherein the copolymer has a propylene content of at least 80 wt % and has a melting point of greater than 115° C., and wherein the hydrocarbon resin comprises an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, or a combination thereof; and
a second layer, B, wherein the second layer comprises a propylene-based elastomer comprising propylene and at least one comonomer selected from ethylene and C₄-C₂₀ alpha-olefins, wherein the propylene-based elastomer has a propylene content of at least 90 wt %, an mm triad tacticity of greater than 75%, a melting point of less than 115° C., and a heat of fusion of less than 65 J/g; and
a third layer, C, wherein the third layer comprises a propylene polymer, wherein the propylene polymer is a propylene homopolymer or a copolymer of propylene and at least one comonomer selected from ethylene and C₄-C₂₀ alpha-olefins, wherein the copolymer has a propylene content of at least 80 wt % and has a melting point of greater than 115° C.;
wherein the multilayer film has a BAC structure, and wherein the film has an Elmendorf TD tear strength, as determined according to ASTM D1922, of less than about 3.0 g/μm, and an 1% MD Secant Modulus, as determined according to ASTM D882, of greater than 750 MPa.

23. The multilayer film of claim 22, wherein the film has a sealing initiation temperature, of less than 105° C.

24. A use of a blend of a propylene polymer and a hydrocarbon resin in a first layer of a multilayer film for reducing Elmendorf TD tear strength and/or increasing MD 1% secant modulus of the multilayer film as compared to the same film not comprising the hydrocarbon resin in the first layer,
wherein the blend comprises from 1 to 50 wt % of the hydrocarbon resin and from 50 to 99 wt % of the propylene polymer based on the weight of the blend,
wherein the propylene polymer is a propylene homopolymer or a copolymer of propylene and at least one comonomer selected from ethylene and C₄-C₂₀ alpha-olefins, wherein the copolymer has a propylene content of at least 80 wt % and has a melting point of greater than 115° C.; and
wherein the hydrocarbon resin comprises an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, or a combination thereof.

25. The use of claim 24, further comprising the use of a propylene-based elastomer in a second layer of the multilayer film for reducing sealing initiation temperature of the multilayer film as compared to the same film not comprising the propylene-based elastomer in the second layer, wherein the propylene-based elastomer comprises propylene and at least one comonomer selected from ethylene and C₄-C₂₀ alpha-olefins, wherein the propylene-based elastomer has a propylene content of at least 75 wt %, an mm triad tacticity of greater than 75%, a melting point of less than 115° C., and a heat of fusion of less than 65 J/g.
